(19) United States
(12) Patent Application Publication
(10) Pub. No.: US 2008/0065292 A1
(43) Pub. Date: Mar. 13, 2008

(54) Security Strategies for an Active Front Steer System

(75) Inventors: Kerfegar K. Katrak, Fenton, MI (US); Robert R. Bolio, Clarkston, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/530,600

(22) Filed: Sep. 11, 2006

(51) Int. Cl. B62D 6/00

(52) U.S. Cl. 701/41

(57) ABSTRACT

A vehicle active front steering (AFS) control system is described herein. The AFS system utilizes variable gear ratio and lead steer control methodologies. The AFS system utilizes independent and supervisory control systems to control the AFS system parameters in accordance with designated security metrics, to lower the time to lock the AFS system angle actuator in the event the security metrics are not met, and to lower likelihood of fault detection errors by checking a difference between a target road wheel angle and an actual road wheel angle obtained from a first control path and, for added security, by checking a difference between the target road wheel angle and the actual road wheel angle from a second control path, as a function of the vehicle velocity. The techniques described herein may check a value of an AFS control parameter from the first control path to the value of the same AFS control parameter from the second control path.

### TECHNICAL FIELD

The present invention generally relates to active front steer (AFS) control systems, and more particularly relates to safety equipment for automotive steering and control systems in active front steering control systems.

### BACKGROUND OF THE INVENTION

Vehicle steering is generally controlled by a driver hand wheel that directs the angle of the vehicle wheels used for steering. The movements of the driver hand wheel are transmitted to the vehicle wheels by mechanical linkages and/or electronic components. The vehicle road wheels that change angle are located in the front of the vehicle in a system referred to as “front steering”. The angle of the road wheels is referred to as road wheel angle.

Active front steering (AFS) is a term referring to the use of electronic components to actively control or assist the steering of a vehicle so as to enhance steering performance beyond that possible by only direct mechanical linkages. There are many possible ways to enhance steering performance; for example, steering can be adapted to the weather conditions, to the behavior and habits of the driver, provide orderly stopping if the driver loses control, enhance the driver hand wheel control by changing steering characteristics, or provide enhanced driver control in the event of a steering mechanism malfunction.

At higher speeds, large changes in the angle of the vehicle wheels can cause undesirable shifts in vehicle direction. Accordingly, precise driver control at high speeds requires subtle changes in the angle of the driver hand wheel. At low and medium speeds, a vehicle generally will be steered into tighter or larger angle turns for parking or manipulating corners. Large turns of the driver hand wheel are usually necessary to make large turns of the vehicle wheels. Driving is easier if the vehicle wheels turn less for corresponding driver hand wheel turns at high speed and more for corresponding driver hand wheel turns at low speed.

In an AFS system, variable gear ratio (VGR) steering is a method for adding and subtracting steering angle to the target road wheel angle implied by the driver's hand wheel input. This can be accomplished by mechanical or electrical components. It is desirable to insure that the VGR system is fail-safe, operates in a safe manner, and does not vary greatly from its intended operational parameters. Lead steer is a method of anticipating the driver's intent at the hand wheel that may be implemented in an automotive control module. Open loop control is the operation of a road wheel angle control without feedback and independent of any supervisory control system. Closed loop control is the operation of a road wheel angle control with feedback from a supervisory control system. The AFS system may combine the VGR and lead steer to ascertain the driver's pinion angle for open loop control. The pinion angle is defined as the actual road wheel angle plus the hand wheel angle. The pinion angle may be divided by a mechanical steering ratio to calculate a VGR steering angle for open loop control. For closed loop control, an angle offset from a supervisory control command is added to the VGR steering angle to determine a target road wheel angle that should be implemented by the steering mechanism.

Furthermore, in an AFS system the target road wheel angle from the driver hand wheel and the actual road wheel angle at the front steering wheels are monitored to assure certain security metrics are met. In automotive parlance, a security metric is a safety performance requirement.

It is desirable to have an AFS system and method that effectively controls the road wheel angle within the security metric requirements, lowers the time to lock the AFS actuator when the security metric requirements are not met, reduces the probability of false failure detection, and accurately detects actual failures during steering control. Other desirable features and characteristics of embodiments of the present invention will become apparent from the subsequent detailed description and the appended claims, taken in conjunction with the accompanying drawings and the foregoing technical field and background.

### BRIEF SUMMARY OF INVENTION

A new method is provided for operating various AFS system features to control the road wheel angle within designated security metric requirements. The techniques described herein can lower the time it takes to lock the AFS actuator if the security metrics are not met, and can reduce the probability of false failures during steering control.

A method according to a first embodiment of the invention is utilized for operating an AFS system for a vehicle, in an open loop mode and in a closed loop mode, having an AFS actuator that influences the road wheel angle for the vehicle. This method obtains a first value for a target angle for controlling the AFS actuator from a first control path, and then measures a first value of an actual angle of the AFS actuator from the first control path, the actual angle being responsive to the target angle. The first value of the target angle and the first value of the actual angles are then compared as a function of vehicle speed to obtain a first comparison value, and an AFS system security mode may be initiated if the first comparison value exceeds a threshold. For added security, the steps above are repeated to obtain a second comparison value as follow: The method further obtains a second value for the same target angle for controlling the AFS actuator from a second control path, and then measures a second value of the same actual angle of the AFS actuator from the second control path. The second value of the target angle and the second value of the actual angles are then compared as a function of vehicle speed to obtain the second comparison value, and an AFS system security mode may be initiated if the second comparison value exceeds a threshold.

A method according to a second embodiment of this invention is utilized for operating an AFS system in an open loop mode. According to the second embodiment of this invention, the AFS system generates a comparison value to check a security mode as follows: The AFS system obtains a first value for an AFS parameter from a first control path and a second value for the AFS parameter from a second control path, and then compares the first value and the second value to obtain a comparison value. The system can then initiate an AFS system security mode if the comparison value exceeds the threshold.

A method according to a third embodiment of this invention is utilized for operating an AFS system in a closed loop mode. According to the third embodiment of this invention, the AFS system generates a comparison value to check a security mode as follow: The AFS system obtains a first value of a first parameter from the first control path and obtains a first value of a second parameter from the first control path and adds the first value of the first parameter to the first value of the second parameter to obtain a first control parameter. The AFS system then obtains a second value of the same first parameter from the second control path and obtains a second value of the same second parameter from the second control path and adds the second value of the same first parameter to the second value of the same second parameter to obtain a second control parameter. The AFS system then compares the first control parameter to the second control parameter to obtain the comparison value and may initiate an AFS system security mode if the comparison value exceeds a threshold.

Other desirable features and characteristics of embodiments of the present invention will become apparent from the subsequent detailed description and the appended claims, taken in conjunction with the accompanying drawings and the foregoing technical field and background.

### DESCRIPTION OF THE DRAWINGS

The present invention will hereinafter be described in conjunction with the following drawing figures, wherein like numerals denote like elements, and

FIG. 1 is a schematic representation of an AFS system configured in accordance with an example embodiment of the invention;

FIG. 2 is a flow chart of an AFS system operating process according to a first embodiment of the invention;

FIG. 3 is a flow chart of an AFS system open loop operating process according to a second embodiment of the invention; and

FIG. 4 is a flow chart of an AFS system closed loop operating process according to a third embodiment of the invention.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of steering control systems and that the vehicle system described herein is merely one example embodiment of the invention.

For the sake of brevity, conventional techniques related to signal processing, data transmission, signaling, actuator control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

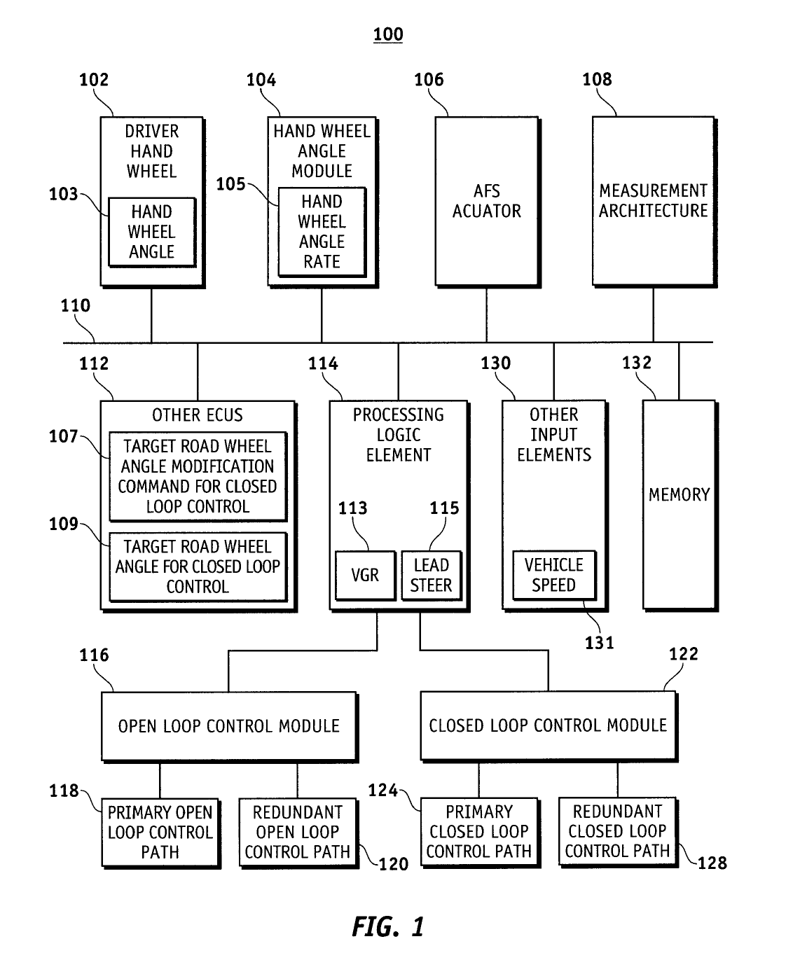

“Connected/Coupled”—The following description refers to elements or nodes or features being “connected”or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 1 depicts one example arrangement of elements, additional intervening elements, devices, features, or components may be present in an embodiment of the invention (assuming that the functionality of the circuit is not adversely affected).

An electronic AFS system uses actuator motors to rotate the front road wheels for a given target road wheel angle. In an electronic AFS system the actuator motor is often controlled by a Pulse Width Modulation (PWM) control signal. The PWM control may include without a limitation a three phase or a single phase PWM signal. The PWM control is utilized to generate analog signals using the modulation of the pulse width or duty cycle of a periodic digital signal to produce controlled analog voltages. For example, if a 12 volt battery is connected to a device and the duty cycle is about 50% alternated between about 12 volts and about zero volts, the effective output voltage is about 50% of that of a constant 12 volts or six volts. Similarly, a duty cycle of X % may give an output voltage of X % of the voltage range and, accordingly, power available may be less than the total power. The quality and smoothness of the analog voltage output can be effectuated with capacitor, inductor, and resistor based passive component circuits.

Electronic AFS systems use chains of electronic parts and software to form a control path. Present AFS systems have a closed loop control mechanism and an open loop control mechanism which uses a combined dual control path. The combined dual control path includes a primary control path and a redundant control path. At present, existing AFS modules compare a target road wheel angle to an actual road wheel angle obtained from the primary or redundant control paths of the combined dual control path. If the difference between the target road wheel angle and the actual road wheel angle is less than or equal to a threshold value, such as 0.5 radians (28.65 degrees), then the AFS actuator is locked. This difference is significantly higher than that required by open loop security metrics, and it takes a much longer time than that required by the security metrics to lock the AFS actuator. Also at present, there is no security diagnostic for the road wheel angle during the open loop control by an AFS module and during the closed loop control between the AFS module and the supervisor module. The only security check for the road wheel angle in the AFS module is during low level PWM control which may be very sensitive to computational variation and may result in increasing false failures.

Methods according to the embodiments of this invention comprise ways of generating comparison values for diagnosing the AFS systems open loop and closed loop operation to control the road wheel angle within designated security metric requirements. The techniques described herein can lower the time it takes to lock the AFS actuator if the security metrics are not met, and can reduce the probability of false failures during steering control.

A method according to the first embodiment of this invention may be utilized for operating an AFS system for a vehicle having an AFS actuator that influences the road wheel angle for the vehicle. This method obtains a value for the target angle for controlling the AFS actuator from a primary control path, and then measures a value of an actual angle of the AFS actuator in the primary control path. The first value of the target angle and the first value of the actual angle are then compared to obtain a primary comparison value. For added security, the method repeats the above steps to develop a redundant comparison value as follow: the method obtains a value for the target angle for controlling the AFS actuator in a redundant control path, and then measures a value of an actual angle of the AFS actuator in the redundant control path. The second value of the target angle and the second value of the actual angle are then compared to obtain a redundant comparison value. The method compares the primary comparison value and initiates a security mode if the primary comparison value exceeds a threshold. For added security, the method also compares the redundant comparison value to the threshold and initiates a security mode if the redundant comparison value excesses the threshold.

A method according to a second embodiment of this invention is utilized for operating an AFS system in an open loop mode. According to the second embodiment of this invention, the AFS system generates a comparison value to diagnose the AFS systems as follow: The AFS system obtains a first value for an AFS parameter from the primary control path control path and a second value for the same AFS parameter from a second control path, and then compares the first value and the second value to obtain a comparison value. The system may then initiate an AFS system security mode if the comparison value exceeds a threshold. This method may be utilized, for example, without limitation, to diagnose an AFS open loop control processor.

A method according to a third embodiment of this invention is utilized for operating an AFS system in a closed loop mode. According to the third embodiment of this invention, the AFS system obtain a comparison value to diagnose the AFS systems as follow: The AFS systems obtains a value of a first parameter from the primary control path and a value of a second parameter from the primary control path and adds the values of the first and second parameters to obtain a primary control parameter. The AFS system then obtains a second value of the same first parameter from the redundant control path and obtains a second value of the same second parameter from the redundant control path and adds the second values of the first and second parameters from the redundant control path to obtain a redundant control parameter. The AFS system then compares the primary control parameter to the redundant control parameter to obtain a comparison value and may initiate an AFS system security mode if the comparison value exceeds a threshold. This method may be utilized, for example, without limitation to diagnose an AFS closed loop control processor.

In the example embodiment of this invention, the threshold may vary as a function of vehicle speed; for example, the threshold may be inversely proportional to the vehicle speed. Upon error detection, the AFS system may initiate an AFS security mode, which may cause the AFS system to revert to a mechanical mode.

To balance the likelihood of detecting a false failure (alpha error) and the likelihood of not detecting a failure when there is one (beta error), the following strategy may be implemented: The comparison between the target angle and the actual angle may be a function of vehicle speed. This strategy allows higher differences between target angle and actual angle at low vehicle speeds, and lower differences between target angle and actual angle at high vehicle speeds.

According to example embodiments of this invention, the target road wheel angle is defined by a boundary condition that has been established by the automotive industry for how much the target road wheel angle can vary as a function of a hand wheel angle and a hand wheel angle rate. Based on the established boundary condition a “bounded” target road wheel angle as a function of vehicle speed may be determined. The “bounded” target road wheel angle may also include the lead steer and the steering variable gear ratio. In the embodiments of this invention, the target road wheel angle used to obtain the comparison values may be equal to the “bounded” target road wheel angle determined by the boundary conditions established by the automotive industry.

Two separate redundant checks may be implemented for the road wheel angle comparisons. During the open loop control, the primary and redundant control paths are compared to each other as function of vehicle speed. This comparison assists in meeting security metrics in the open loop control, which are directly attributed to the road wheel angle. During the closed loop control, the primary control path and the redundant control path may be compared to each other also as a function of vehicle speed. This comparison assists in meeting security metrics in the closed loop control, which are directly attributed to the road wheel angle. The rationale for different open loop control and closed loop control checks is that the security metrics may be different. The comparisons mentioned above are typically expected to be linearly interpolated for reduced algorithm complexity but are not expected to be monotonically increasing or decreasing.

For each of the parameters (for example, target road wheel angle and actual road wheel angle) mentioned above, the methodology described herein selects one of the parameters between the primary and redundant control paths, or selects an average or weighted average between these parameters. The single redundant values are used for the primary and redundant control paths for low level PWM control. Hence, the check between the control and redundant path for the low level PWM control can be based on computational error only and is not based on security metrics. This results in lowering the alpha error and will allow the open loop control and closed loop control to meet the security metrics.

FIG. 1 is a schematic representation of an AFS system 100 in accordance with the example embodiments of this invention. The various block modules depicted in FIG. 1 may be realized in any number of physical components or modules located throughout the vehicle or the AFS system 100. A practical AFS system 100 may include a number of electrical control units (ECUs), computer systems, and components other than those shown in FIG. 1. Conventional subsystems, features, and aspects of AFS system 100 will not be described in detail herein.

AFS 100 generally includes a driver hand wheel 102, a hand wheel angle rate module 104, an AFS actuator 106, a measurement architecture 108, an interconnect bus or other coupling arrangement 110, other engine control units (ECUs) 112, a processing logic element 114 which comprises a VGR module 113, and a lead steer module 115, an open loop control module 116 connected to an open loop control path having two sub-paths (a primary open loop control path 118 and a redundant open loop control path 120), a closed loop control module 122 connected to a closed loop control path having two sub-paths (a primary closed loop control path 124 and a redundant closed loop control path 128), other input elements 130 and a suitable amount of memory 132. In practice, these elements may be coupled together using interconnect bus 110, which may be a CAN bus in a typical vehicle application.

The memory 132 may be any suitable data storage area that is formatted to support the operation of the AFS system 100. Memory 132 is configured to store, maintain, and provide data as needed to support the functionality of the AFS system 100 in the manner described below. In practical embodiments, memory 132 may be realized as RAM memory, flash memory, ROM memory, EPROM memory, EEPROM memory, registers, a hard disk, a removable disk, a CD-ROM, or any other form of storage medium known in the art. The memory 132 may be coupled to the measurement architecture 108 to store the AFS parameters. These AFS parameters may include, for example, the target road wheel angle for the vehicle, the actual road wheel angle for an AFS actuator in the AFS system, the target VGR steering angle for the AFS system, the target lead steer angle for the AFS system, and the comparison values, as a function of vehicle speed, of the target road wheel angle and the actual road wheel angle for controlling the AFS. Other AFS parameters may be stored in the memory, including, without limitation, the vehicle velocity, the hand wheel angle, the hand wheel rate, target road wheel angle for closed loop control, and the angle modification command for closed loop control.

Processing logic element 114 may include any number of distinct processing modules or components that are configured to perform the tasks, processes, and operations described in more detail herein. Although only one processing block is shown in FIG. 1, a practical implementation may utilize any number of distinct physical and/or logical processors, which may be dispersed throughout AFS system 100. In practice, the processing logic element 114 may be implemented or performed with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. A processor may be realized as a microprocessor, a controller, a microcontroller, or a state machine. A processor may also be implemented as a combination of computing devices, e.g., a combination of a digital signal processor and a microprocessor, a plurality of microprocessors, one or more microprocessors in conjunction with a digital signal processor core, or any other such configuration.

Generally, the AFS system 100 operates as follows. Driver manipulation of driver hand wheel 102 determines a hand wheel angle 103 and causes AFS actuator 106 to cooperate with the driver hand wheel 102 to rotate the front road wheels for a given target road wheel angle. In addition, lead steer 115 may cooperate with the driver hand wheel 102 to anticipate the driver intent at the hand wheel 102. The hand wheel angle rate 105 along with the vehicle velocity 131 determines the lead steer 115. Furthermore, VGR steering angle is obtained from VGR module 113 by combining the hand wheel angle 103 with the vehicle velocity 131. The VGR module 113 and the lead steer 115 may both be activated for a closed loop and an open loop control of the vehicle. The measurement architecture 108 may be configured to measure a plurality of AFS control parameters. Data from the measurement architecture 108 can be processed by the processing logic element 114 to provide the control parameters to the control modules. In an example embodiment, the measurement architecture 114 may, include, without a limitation, an AFS actuator angle sensor and a plurality of microprocessors to measure the AFS parameter values. The other ECUs 112 may, include, without limitations, a target road wheel angle modification command for closed loop control 107 and a target road wheel angle for the closed loop control 109.

The processing logic element 114 may be coupled to control modules utilized by AFS system 100, such as open loop control module 116 and closed loop control module 122. In turn, the control modules are coupled to, include, or utilize control paths: Primary open loop control path 118, redundant open loop control path 120, primary closed loop control path 124 and redundant closed loop control path 128. The control paths are configured to indicate values for the AFS system control parameters and are suitably configured to control the operation of AFS system 100 when it functions in the respective open loop or closed loop mode.

Normally, the vehicle operates in an open loop control mode. When operating in the open loop control mode, the AFS system 100 may utilize the open loop control module 116. The open loop control corresponds to the operation of a road wheel angle control without feedback and independent of any supervisory control system. During open loop operation, control parameter values from the primary open loop control path 118 and the redundant open loop control paths 120 are compared to each other as a function of vehicle speed. This comparison assists in meeting security metrics in the open loop control, which are directly attributed to the road wheel angle. During the open loop control, the AFS system 100 obtains the hand wheel angle 103 and the vehicle velocity 131 and computes the VGR steering angle from VGR module 113. AFS 100 obtains the hand wheel angle rate 105 along with the vehicle velocity 131 and computes the lead steer angle from the lead steer module 115. The AFS 100 incorporates the lead steer angle and the VGR steering angle to compute the actual road wheel angle based on what the diver hand wheel is commanding.

When operating in a closed loop control mode, the AFS system 100 may utilize the closed loop control module 122. The closed loop control corresponds to the operation of a road wheel angle control with feedback from a supervisory control system. During closed loop operation, AFS control parameter values from the primary closed loop control path 124 and the redundant closed loop control path 128 may be compared. This comparison may be performed as a function of vehicle speed. Also, this comparison assists in meeting security metrics in the closed loop control which are attributed to the road wheel angle. The closed loop control is activated only in a stability event defined by specific criterion set by the security metrics. The closed loop module functionality is similar to the open loop functionality except that it computes the actual road wheel angle based on feedback from the vehicle parameters instead of directly from what the driver hand wheel is commanding. The vehicle parameters include, without limitation, a yaw rate and a yaw acceleration to compensate for the vehicle lateral maneuvers when appropriate.

The primary open loop control path 118 is configured to indicate values for the AFS open loop control 116 parameters, and the redundant open loop control path 120 is independent of the primary open loop control path 118. The redundant open loop control path 120 is configured to indicate redundant values for the AFS open loop control 116 parameters. The primary closed loop control path 124 is configured to indicate values for the AFS closed loop control 122 parameters, and the redundant closed loop control path 128 is independent of the primary closed loop control path 124. The redundant closed loop control path 128 is configured to indicate redundant values for the AFS closed loop control 122 parameters.

Each of the four loop control paths is independent and distinct from all of the other loop control paths. For example, the primary open loop control path 118 is independent of the redundant open loop control path 120, the primary closed loop control path 124, and the redundant closed loop control path 128. Likewise, the redundant open loop control path 120 is independent of the primary open loop control path 118, the redundant closed loop control path 128, and the primary closed loop control path 124.

The processing logic element 114 is configured to process the AFS system parameters in the manner described herein. In one example embodiment, the processing logic element 114 obtains a first value for a parameter from the primary control path, a second value for the same parameter from the redundant control path, compares the first value and the second value to obtain a comparison value, and initiates an AFS system security mode if the comparison value exceeds a threshold. The processing logic element 114 may be configured to compare the first value and the second value as a function of vehicle speed.

An AFS system operating process according to one embodiment of this invention is described below. The process obtains a target road wheel angle for controlling the AFS actuator, and then measures an actual road wheel angle for the AFS actuator, where the actual road wheel angle is responsive to the target road wheel angle. The target road wheel angle and the actual road wheel angle are then compared as a function of vehicle speed to obtain comparison values, and an AFS system security mode may be initiated if the comparison values exceed a threshold. For added security, two comparison values are developed as follow: A first comparison value is developed using values of the actual and the target road wheel angles from a primary control path, and a second comparison value is developed using values of the actual and target road wheel angles from a redundant control path. In response to the security mode, the AFS system may revert to a mechanical mode.

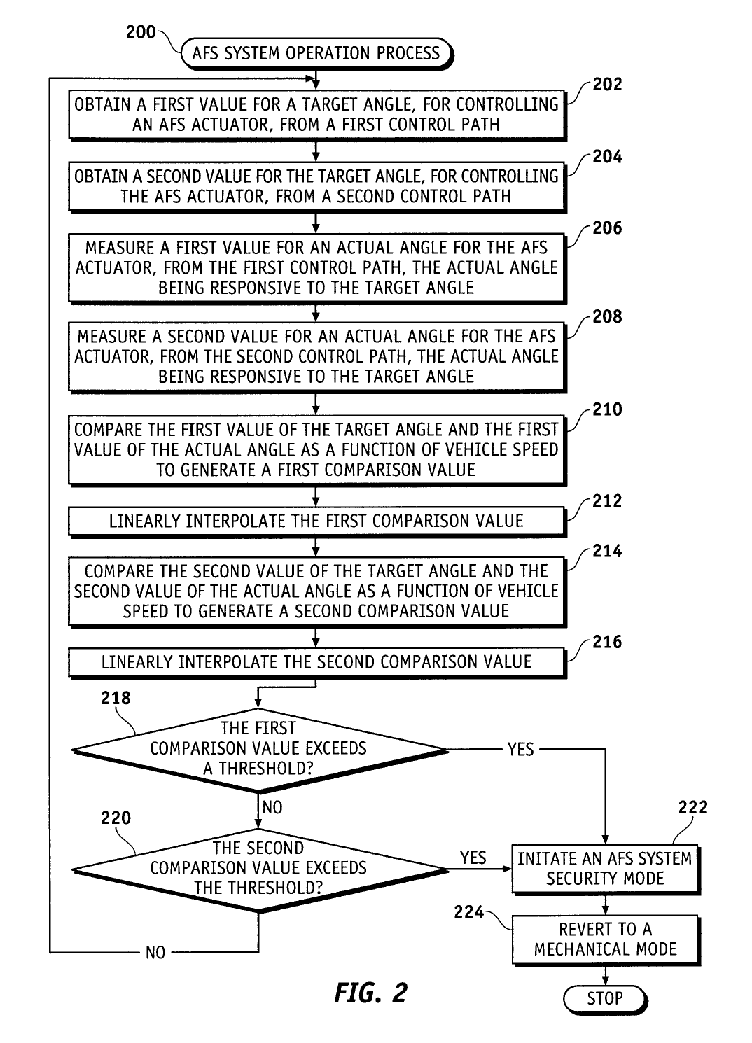

FIG. 2 is a flow chart of an AFS system operating process 200 according to the first embodiment of this invention. The various tasks performed in connection with process 200 may be performed by software, hardware, firmware, or any combination thereof. For illustrative purposes, the following description of process 200 may refer to elements mentioned above in connection with FIG. 1. In practical embodiments, portions of process 200 may be performed by different elements of the AFS system 100, e.g., driver hand wheel 102, hand wheel angle rate module 104, AFS actuator 106, measurement architecture 108, other ECUs 112, processing logic element 114, open loop control module 116, or closed loop control module 122.

The AFS system operating process 200 may begin by obtaining a first value for a target angle, for controlling an AFS actuator, from a first control path (task 202) and may proceed to obtain a second value for the same target angle, for controlling the AFS actuator, from a second control path (task 204). The target angle may, for example, may be obtained from memory 132, processing logic element 114, open loop control module 116, or closed loop control module 122.

The process 200 may then measure, using the measurement architecture 108, the AFS actual actuator angles for comparison to the target angle obtained above. Process 200 may measure a first value for an actual angle for the AFS actuator, from the first control path (task 206) and proceed to measure a second value for the same actual angle for the AFS actuator, from the second control path (task 208). As mentioned above, the actual angle is responsive to the target angle because the target angle represents the desired actual angle, the actual angle being responsive to the target angle.

Process 200 may then compare the first value of the target angle and the first value of the actual angle as a function of vehicle speed to obtain a first comparison value (task 210) from the first control path. The comparison value may be based upon an average value of the target road wheel angle and the actual road wheel angle, or a weighted average value of the target road wheel angle and the actual road wheel angle.

In this embodiment, the weighted average is a function of how the driver would normally behave. At lower vehicle speeds, the actual road wheel angle is weighted heavier than the target road wheel angle to account for the bigger angle changes that would be indented by the driver at these speeds. For example, if an average value of the actual road wheel angle is about 20 degrees and an average value of the target road wheel angle is about 30 degrees, in this embodiment, about 22 degrees may be acceptable for the comparison value based on the weighted average (instead of about 10 degrees difference based on the average values). At higher vehicle speeds, smaller angel changes would be intended by the driver; therefore, the actual road wheel angle is weighted less than the target road wheel angle at these speeds. In this example, about 28 degrees may be acceptable for the comparison value based on the weighted average (instead of the 10 degrees difference based on the average values) to account for the smaller actual road wheel angle changes that may be normally intended by the driver at the higher speeds. The weighing function which determines the functional relationship between the comparison value and the vehicle velocity may include, without limitation, an exponentially weighted moving average function.

In this example, process 200 may then linearly interpolate the first comparison value (task 212) and proceed to compare the second value of the target angle and the second value of the actual angle as a function of vehicle speed to obtain a second comparison value (task 214) and then linearly interpolate the second comparison value (task 216). The linear interpolations task 212 and 216 are performed to reduce algorithm complexity.

The algorithm complexity is reduced by utilizing a plurality of linear interpolation tables corresponding to a plurality of driver selectable modes to interpolate the comparison values. Utilizing the linear interpolation tables allows reducing the algorithm complexity because the linear interpolation tables do not require writing extra software codes that may be otherwise necessary, for more complex interpolations such as, without limitation, a parabolic interpolation. The comparison values are obtained by linearly interpolating between two contiguous values in an interpolation table.

In this example, the comparisons performed during task 210 and 214 may be performed, as a function of vehicle speed using a plurality of functional relationships including, without limitation, a parabolic functional relationship between the vehicle speed and the comparison values.

Process 200 may then compare the interpolated first comparison value to a threshold (task 218). If the first comparison value exceeds the threshold, process 200 may initiate an AFS system security mode (task 222) and revert to a mechanical mode (task 224). If the first comparison value does not exceed the threshold, process 200 may then compare the second comparison value to the threshold (220). If the second comparison value exceeds the threshold, process 200 may proceed to initiate the AFS security mode (222). In this example embodiment, the AFS system security mode causes the AFS system to revert to a mechanical mode (task 224). The AFS system may revert to the mechanical mode by mechanical phase locking an AFS actuator motor. The AFS actuator motor may also be electrically locked prior to the mechanical phase locking to prevent potential damage to a lock holder in the AFS system. In the mechanical mode, the driver may be controlling the vehicle mechanically using a fixed VGR steering. If the comparison values do not exceed the threshold value, process 200 may lead back to task 202 for continued operation.

Since driving is easier if the vehicle wheels turn less for driver hand wheel turns at high speed and more for driver hand wheel turns at low speed, the threshold may be inversely proportional to the vehicle speed. Alternatively, functional relationships between the vehicle speed and the threshold may include, without limitation, the exponentially weighted moving average.

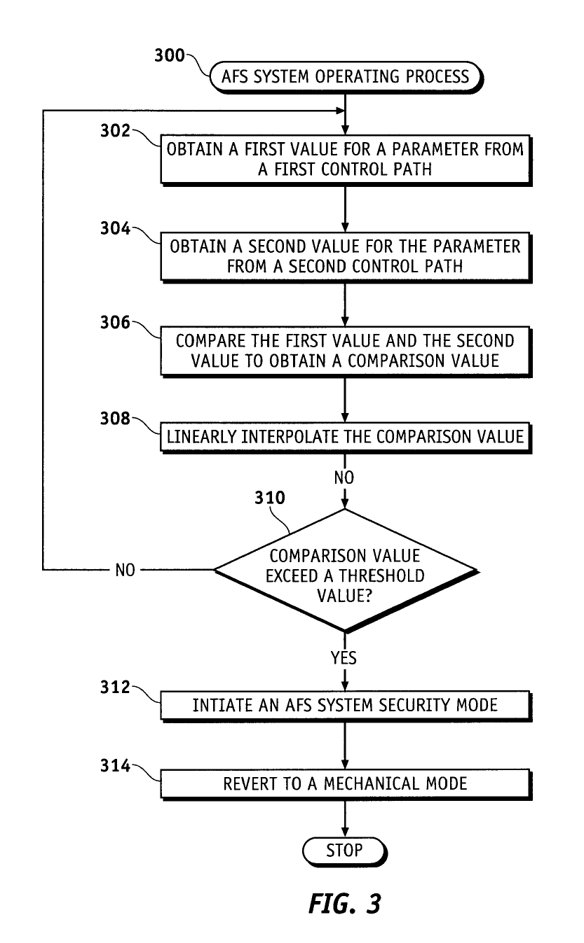

FIG. 3 is a flow chart of an AFS system open loop operating process 300 according to second embodiment of this invention. The AFS operating process 300 may begin by obtaining a first value for a parameter from a first control path of the AFS system (task 302). The first control path may, for example, be a primary control path as described above. The parameter may be any measurable quantity, feature, state, status, or quality associated with the AFS system and/or any portion of the AFS system. In this regard, the parameter may be, without limitation: a target road wheel angle for the vehicle, an actual road wheel angle for an AFS actuator in the AFS system, a target VGR steering angle for the AFS system, or a target lead steer angle for the AFS system, target road wheel, pinion angle, vehicle speed, hand wheel angle and hand wheel rate. The process 300 may then obtain a second value for that same parameter from a second control path (task 304). The second control path may, for example, be a redundant control path as described above. In this example, the primary and redundant control paths are independent of each other and, ideally, the primary and redundant control paths operate in an identical manner.

Process 300 may proceed to compare the first value and the second value to obtain a comparison value (task 306). The comparison value assists in meeting the security matrices by balancing the alpha and beta error. For example, it is desirable to have a threshold value close to the alpha error and far from the beta error. For example, if the alpha error is about 0.2 degrees at a given vehicle speed and the beta error is about 0.5 degrees at the given vehicle speed it is desirable to set the threshold value to about 0.3 degrees to meet the security metrics at the given vehicle speed.

According to one example embodiment of this invention, the comparison value is based upon an average of the first value and the second value. The comparison value is computed by taking the absolute value of the difference between an average value of the first value and an average value of the second value.

Process 300 may then linearly interpolate the comparison value (task 308) as described above in the context of process 200. Process 300 may then compare the comparison value to a threshold (task 310) and if the comparison value exceeds the threshold, process 300 may initiate an AFS system security mode (task 312), and proceed to revert to a mechanical mode (314). The AFS system may revert to the mechanical mode by mechanical phase locking the AFS actuator motor. In the mechanical mode, the driver may be controlling the vehicle mechanically using one fixed VGR steering angle. The driver may key off the ignition so that the AFS system has chance to recover or service the AFS system otherwise. If the comparison value does not exceed the threshold value, process 200 may lead back to task 302 for continued operation.

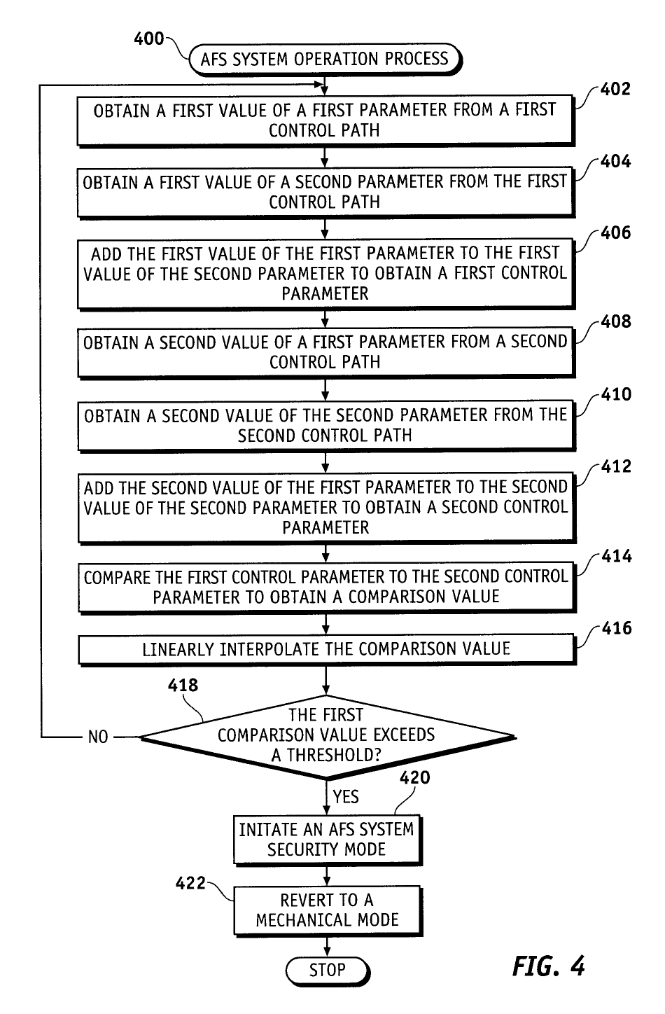

FIG. 4 is a flow chart of an AFS system closed loop operating process 400 according to the third embodiment of the invention. The AFS operating process 400 may begin by obtaining a first value of a first parameter from a first control path (task 402) of the AFS system. The first control path may, for example, be a primary control path as described above. The parameter may be any measurable quantity, feature, state, status, or quality associated with the AFS system and/or any portion of the AFS system. In this regard, the parameter may be, without limitation: a target road wheel angle for the vehicle, an actual road wheel angle for an AFS actuator in the AFS system, a target VGR steering angle for the AFS system, or a target lead steer angle for the AFS system, pinion angle, hand wheel angle and hand wheel rate. Process 400 may then obtain a first value of a second parameter from the first control path (task 404). The second parameter may include, without limitation: a target road wheel angle modification command and a VGR steering angle to potentially compensate for the vehicle maneuvers. Process 400 may then add the first value of the first parameter to the first value of the second parameter to obtain a first control parameter to develop a comparison value. Process 400 may then obtain a second value of that same that same first parameter from a second control path (task 408) and proceed to obtain a second value of the same second parameter from the second control path (task 410). The second control path may, for example, be a redundant control path as described above. In this example, the primary and redundant control paths are independent of each other and, ideally, the primary and redundant control paths operate in an identical manner. Process 400 then add the second value of the same first parameter to the second value of the same second parameter to obtain a second control parameter to develop the comparison value (task 412). Process 400 may then compare the first control parameter to the second control parameter to obtain a comparison value (task 416). The comparison value assists in meeting the security matrices by balancing the alpha error and beta as described above in the context of process 200.

According to one example embodiment of this invention, the comparison value is based upon an average of the first value and the second value. The comparison value is computed by taking the absolute value of the difference between an average value of the first value and an average value of the second value. Process 400 may then linearly interpolate the comparison value (task 416) as described above in the context of process 200. Process 400 may then compare the comparison value to a threshold (task 418) and if the comparison value exceeds the threshold, process 400 may initiate an AFS system security mode (task 420), and proceed to revert to a mechanical mode (422). The AFS system may revert to the mechanical mode by mechanical phase locking the AFS actuator motor. In the mechanical mode, the driver may be controlling the vehicle mechanically using one fixed VGR steering angle. The driver may key off the ignition so that the AFS system has a chance to recover or service the AFS system otherwise. If the comparison value does not exceed the threshold value, process 400 may lead back to task 402 for continued operation.

Using the embodiments of this invention allows the AFS open loop control and close loop control systems to control the road wheel angle within the security metrics, lower the time to lock the AFS actuator in the event the security metrics are not met, and lower the likelihood of the alpha and the beta errors.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for operating an active front steer (AFS) system for a vehicle having an AFS actuator that influences road wheel angle for the vehicle, having a first control path and a second control path, the method comprising:
obtaining a first value for a target angle, for controlling the AFS actuator, from the first control path;
obtaining a second value for the target angle, for controlling the AFS actuator, from the second control path;
measuring a first value for an actual angle for the AFS actuator, from the first control path, the actual angle being responsive to the target angle;
measuring a second value for the actual angle for the AFS actuator, from the second control path, the actual angle being responsive to the target angle;
comparing the first value of the target angle and the first value of the actual angle as a function of vehicle speed to obtain a first comparison value;
comparing the second value of the target angle and the second value of the actual angle as a function of vehicle speed to obtain a second comparison value;
initiating an AFS system security mode if the first comparison value exceeds a threshold; and
initiating an AFS system security mode if the second comparison value exceeds the threshold.

2. A method according to claim 1, wherein the threshold varies as a function of vehicle speed.

3. A method according to claim 2, wherein the threshold is inversely proportional to the vehicle speed.

4. A method according to claim 1, wherein:
the first comparison values is based upon an average value of the first target angle and the first actual angle; and
the second comparison values is based upon an average value of the second target angle and the second actual angle.

5. A method according to claim 1, wherein:
the first comparison value is based upon a weighted average value of the first target angle and the first actual angle; and
the second comparison values is based upon a weighted average value of the second target angle and the second actual angle.

6. A method according to claim 1, wherein:
the first comparison value is linearly interpolated; and
the second comparison value is linearly interpolated.

7. A method according to claim 1, further comprising reverting to a mechanical mode if the first comparison value exceeds the threshold.

8. A method according to claim 1, further comprising reverting to a mechanical mode if the second comparison value exceeds the threshold.

9. A method for operating an active front steer (AFS) system for a vehicle, the system having a first and a second control path, the method comprising:
obtaining a first value for a parameter from the first control path;
obtaining a second value for the parameter from the second control path;
comparing the first value and the second value to obtain a comparison value; and
initiating an AFS system security mode if the comparison value exceeds a threshold.

10. A method according to claim 9, wherein the parameter comprises a road wheel steering angle for the vehicle.

11. A method according to claim 9, wherein the parameter comprises an actual actuator angle for an AFS actuator in the AFS system.

12. A method according to claim 9, wherein the parameter comprises a target variable gear ratio steering angle for the AFS system.

13. A method according to claim 9, wherein the comparison value is based upon an average of the first value and the second value.

14. A method according to claim 9, further comprising:
obtaining a first value of a first parameter from the first control path;
obtaining a first value of a second parameter from the first control path;
adding the first value of the first parameter to the first value of the second parameter to obtain a first control parameter;
obtaining a second value of the first parameter from the second control path;
obtaining a second value of the second parameter from the second control path;
adding the second value of the first parameter to the second value of the second parameter to obtain a second control parameter;
comparing the first control parameter to the second control parameter to obtain a comparison value; and
initiating an AFS system security mode if the comparison value exceeds a threshold.

15. A method according to claim 14, wherein;
the first parameter comprises a variable gear ratio angle; and
the second parameter comprises a target road wheel angle modification command.

16. An active front steer (AFS) system for a vehicle, the AFS system comprising:
an AFS actuator that influences a plurality of AFS control parameters;
a measurement architecture coupled to the AFS actuator and configured to measure the plurality of AFS control parameters;
a primary control path configured to indicate values for the AFS control parameters;
a redundant control path that is independent of the primary control path, the redundant control path being configured to indicate redundant values for the AFS control parameters; and
a processing logic element coupled to the primary and redundant control paths and configured to:
obtain a first value for a parameter from the primary control path;
obtain a second value for the parameter from the redundant control path;
compare the first value and the second value to obtain a comparison value; and
initiate an AFS system security mode if the comparison value exceeds a threshold.

17. An AFS system according to claim 16, wherein:
the primary control path is a closed loop primary control path;
the redundant control path is a closed loop redundant control path;
the AFS system further comprises an open loop primary control path that is independent of the closed loop primary control path and independent of the closed loop redundant control path, the open loop primary control path being configured to indicate open loop values for the AFS control parameters; and
the AFS system further comprises an open loop redundant control path that is independent of the closed loop primary control path, independent of the closed loop redundant control path, and independent of the open loop primary control path, the open loop redundant control path being configured to indicate redundant open loop values for the AFS control parameters.

18. An AFS system according to claim 16, wherein the processing logic element is configured to compare the first value and the second value as a function of vehicle speed.

19. An AFS system according to claim 16, wherein the parameter represents a comparison, as a function of vehicle speed, of a target angle for controlling the AFS actuator with an actual measured angle for the AFS actuator, the actual measured angle being responsive to the target angle.

20. An AFS system according to claim 16, wherein the AFS system is configured to revert to a mechanical mode if the comparison value exceeds the threshold.
